(19) United States
(12) Patent Application Publication
(10) Pub. No.: US 2026/0129682 A1
(43) Pub. Date: May 7, 2026

(54) COLLISION DETECTION AND MANAGEMENT IN P-EDCA

(71) Applicant: Samsung Electronics Co., Ltd., Suwon-si (KR)

(72) Inventors: Yue Qi, Plano, TX (US); Rubayet Shafin, Frisco, TX (US); Peshal Nayak, Plano, TX (US); Vishnu Vardhan Ratnam, Frisco, TX (US); Boon Loong Ng, Plano, TX (US); Bilal Sadiq, Plano, TX (US)

(21) Appl. No.: 19/359,607

(22) Filed: Oct. 15, 2025

Related U.S. Application Data
(60) Provisional application No. 63/715,395, filed on Nov. 1, 2024.
(60) Provisional application No. 63/717,527, filed on Nov. 7, 2024.
(60) Provisional application No. 63/724,168, filed on Nov. 22, 2024.
(60) Provisional application No. 63/738,239, filed on Dec. 23, 2024.
(60) Provisional application No. 63/770,661, filed on Mar. 12, 2025.
(60) Provisional application No. 63/800,848, filed on May 6, 2025.

(51) Int. Cl. H04W 74/0808

(52) U.S. Cl. CPC H04W 74/0825

(57) ABSTRACT

An access point (AP) includes a transceiver, and a processor operably coupled to the transceiver. The processor is configured to detect, when starting a prioritized enhanced distributed channel access (P-EDCA), collision of one or more defer signal (DS) transmissions from a plurality stations (STAs), or detect, during a P-EDCA contention period, collision of frames initiating transmissions from the plurality of STAs. The processor is also configured to, in response to detection of collision of the one or more DS transmission, or collision of the frames initiating the transmission from the plurality of STAs, cause the transceiver to transmit, within the P-EDCA contention period, an additional DS for the AP to manage contention of multiple frame transmissions among the plurality of STAs. The format of the DS and its operating bandwidth are revealed.

### CROSS-REFERENCE TO RELATED APPLICATION(S) AND CLAIM OF PRIORITY

This application claims priority under 35 U.S.C. § 119 (e) to U.S. Provisional Patent Application No. 63/715,395 filed on Nov. 1, 2024, U.S. Provisional Patent Application No. 63/717,527 filed on Nov. 7, 2024, U.S. Provisional Patent Application No. 63/724,168 filed on Nov. 22, 2024, U.S. Provisional Patent Application No. 63/738,239 filed on Dec. 23, 2024, U.S. Provisional Patent Application No. 63/770,661 filed on Mar. 12, 2025, and U.S. Provisional Patent Application No. 63/800,848 filed on May 6, 2025. The above-identified provisional patent applications are hereby incorporated by reference in their entirety.

### TECHNICAL FIELD

This disclosure relates generally to wireless networks. More specifically, this disclosure relates to enhanced distributed channel access (EDCA) enhancement in multi-basic service set (BSS).

### BACKGROUND

Wireless Local Area Network (WLAN) technology allows devices to access the internet in the 2.4 GHz, 5 GHZ, 6 GHz or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax etc.

### SUMMARY

This disclosure provides apparatuses and methods for EDCA enhancement in multi-BSS.

In one embodiment, an access point (AP) is provided. The AP includes a transceiver, and a processor operably coupled to the transceiver. The processor is configured to detect, when starting a prioritized enhanced distributed channel access (P-EDCA), collision of one or more defer signal (DS) transmissions from a plurality of stations (STAs), or detect, during a P-EDCA contention period, collision of frames initiating transmissions from the plurality of STAs. The processor is also configured to, in response to detection of collision of the one or more DS transmission, or collision of the frames initiating the transmission from the plurality of STAs, cause the transceiver to transmit, within the P-EDCA contention period, an additional DS for the AP to manage contention of multiple frame transmissions among the plurality of STAs.

In another embodiment, a STA is provided. The STA includes a processor, and a transceiver operably coupled to the processor. The transceiver is configured to transmit, during a start of a P-EDCA, a first DS, or transmit, during a P-EDCA contention period, a frame initiating transmissions from the STA. The transceiver is also configured to receive, from an AP, within the P-EDCA contention period, a second DS for the AP to manage contention of frame transmissions including the DS or the frame initiating the transmissions by the STA.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to various embodiments of the present disclosure;

FIG. 2A illustrates an example AP according to various embodiments of the present disclosure;

FIG. 2B illustrates an example STA according to various embodiments of this disclosure;

FIGS. 3A and 3B illustrate an example of a collision in a multi-BSS environment according to embodiments of the present disclosure;

FIG. 4 illustrates an example of enhanced EDCA with collision and retransmission with RTS according to embodiments of the present disclosure;

FIG. 5 illustrates an example of enhanced EDCA with collision and retransmission according to embodiments of the present disclosure;

FIG. 6 illustrates an example of Hip EDCA among APs after multiple rounds of contention according to embodiments of the present disclosure;

FIG. 7 illustrates an example of Hip EDCA among APs after a single round of contention according to embodiments of the present disclosure;

FIG. 8 illustrates an example of Hip EDCA among APs according to embodiments of the present disclosure;

FIG. 9 illustrates an example Hip EDCA mode relationship according to embodiments of the present disclosure;

FIG. 10 illustrates an example mechanism for Hip EDCA with MAP coordination in LL sessions according to embodiments of the present disclosure;

FIG. 11 illustrates an of Hip EDCA with MAP coordination with an LL indication according to embodiments of the present disclosure;

FIG. 12 illustrates an of Hip EDCA with MAP coordination in LL TWT according to embodiments of the present disclosure;

FIGS. 13A and 13B illustrate an example signaling design for a Hip EDCA RTS frame according to embodiments of the present disclosure;

FIGS. 14A and 14B illustrate an example signaling design for a Hip EDCA DS-CTS frame according to embodiments of the present disclosure;

FIG. 15 illustrates an example signaling design for a multi-FCS frame according to embodiments of the present disclosure;

FIG. 16 illustrates example information fields in a DS from an AP according to embodiments of the present disclosure;

FIG. 17 illustrates example information fields in a CTS-to self or ACK from an AP according to embodiments of the present disclosure;

FIG. 18 illustrates an example of a prioritized STA sending an MU-RTS after obtaining the channel according to embodiments of the present disclosure;

FIG. 19 illustrates an example of LL STAs sending MU-RTS as defer signals according to embodiments of the present disclosure;

FIG. 20 illustrates an example of LL STAs sending MU-RTS and/or RTS/CTS as defer signals according to embodiments of the present disclosure;

FIG. 21 illustrates an example method for EDCA enhancement in multi-BSS according to embodiments of the present disclosure; and

FIG. 22 illustrates another example method for EDCA enhancement in multi-BSS according to embodiments of the present disclosure.

### DETAILED DESCRIPTION

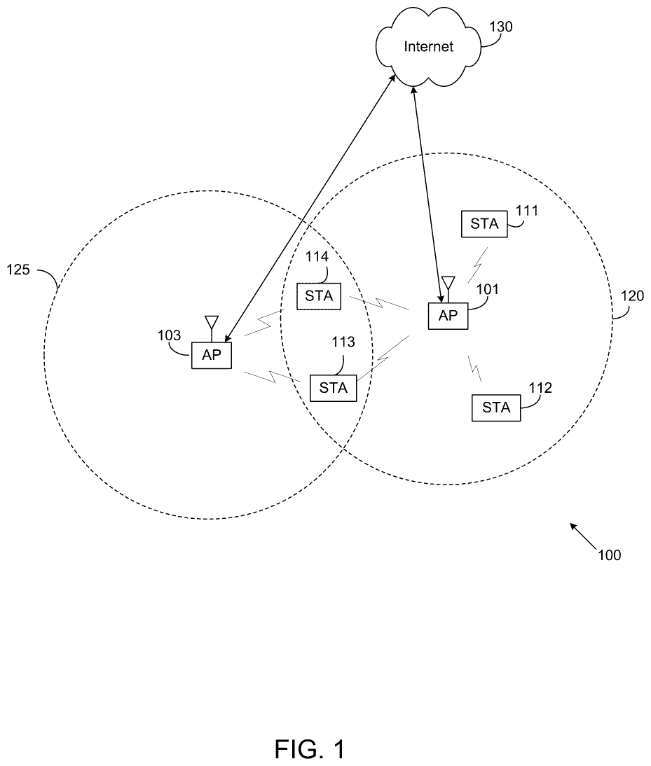

FIGS. 1 through 22, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged system or device.

Existing WLAN standards support multiple bands of operation, where an access point (AP) and a non-AP device may communicate with each other, called links. Thus, both the AP and non-AP device may be capable of communicating on different bands/links, which is referred to as multi-link operation (MLO). Devices capable of such MLO are referred to as multi-link devices (MLDs).

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating multi-link adaptation based on network quality monitoring. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

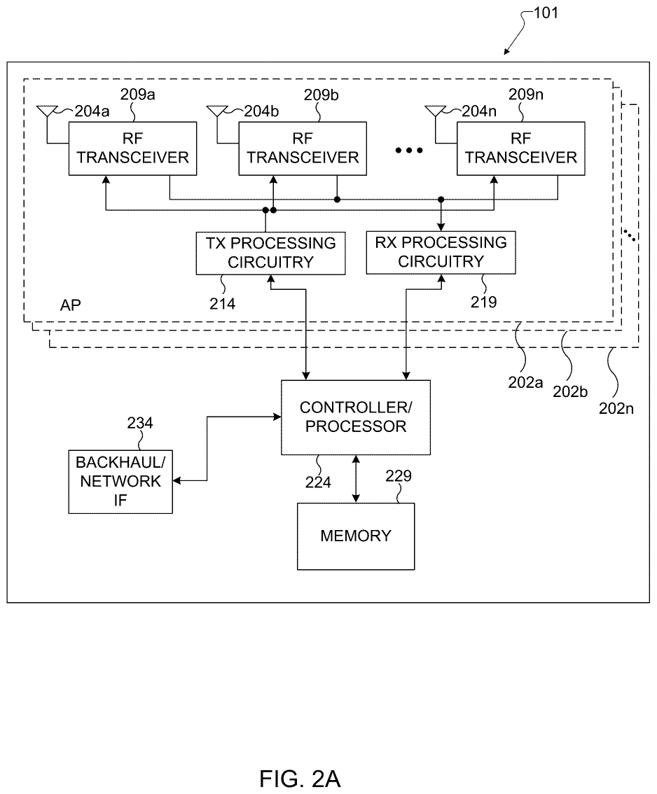

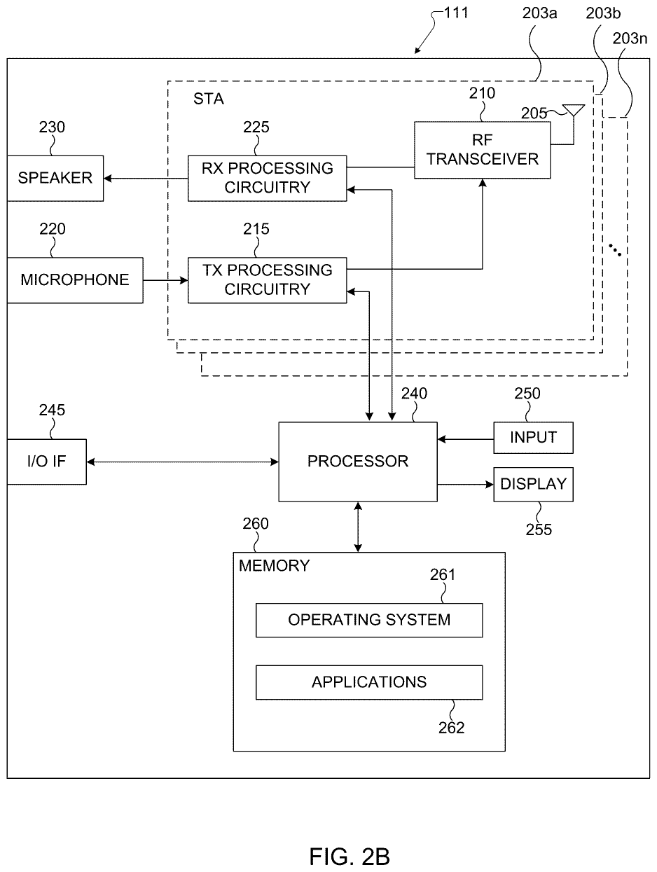

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHZ, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHZ, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support orthogonal frequency division multiple access (OFDMA) operations in which outgoing signals are assigned to different subsets of subcarriers for different recipients (e.g., different STAs 111-114). Any of a wide variety of other functions could be supported in the AP MLD 101 by the controller/processor 224 including facilitating multi-link adaptation based on network quality monitoring. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for facilitating multi-link adaptation based on network quality monitoring. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHZ, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHZ, or 6 GHz, the outgoing RF signals transmitted by each affiliated STA may be at a different frequency of RF.

The controller/processor 240 can include one or more processors and execute the basic OS program 261 stored in the memory 260 in order to control the overall operation of the non-AP MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to facilitate EMLMR operations for MLDs in WLANs. In some embodiments, the controller/processor 240 includes at least one microprocessor or microcontroller.

The controller/processor 240 is also capable of executing other processes and programs resident in the memory 260, such as operations for facilitating multi-link adaptation based on network quality monitoring. The controller/processor 240 can move data into or out of the memory 260 as required by an executing process. In some embodiments, the controller/processor 240 is configured to execute a plurality of applications 262, such as applications for facilitating multi-link adaptation based on network quality monitoring. The controller/processor 240 can operate the plurality of applications 262 based on the OS program 261 or in response to a signal received from an AP. The main controller/processor 240 is also coupled to the I/O interface 245, which provides non-AP MLD 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the non-AP MLD 111 can use the touchscreen 250 to enter data into the non-AP MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the controller/processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

Recently, a significant focus has been given to reducing the channel access delay for low-latency traffic (LLT) required by real-time applications (RTAs) in wireless networks. For example, it has been proposed to define at least one mode of operation capable of improving the tail of the latency distribution and jitter compared to Extremely High Throughput MAC/PHY operation. Reducing the channel access delay for LLT is desirable for several reasons:
New applications (including metaverse, augmented and virtual reality, robotics, industrial automation for industrial IoT, logistics and smart agriculture) have lower latency demands.
Lower latency leads to a better customer experience (especially worst-case latency/jitter mattering).
Low latency communication is becoming an essential building block for RTAs. Some use cases may necessitate less than 5 ms of latency and 2 ms of jitter.

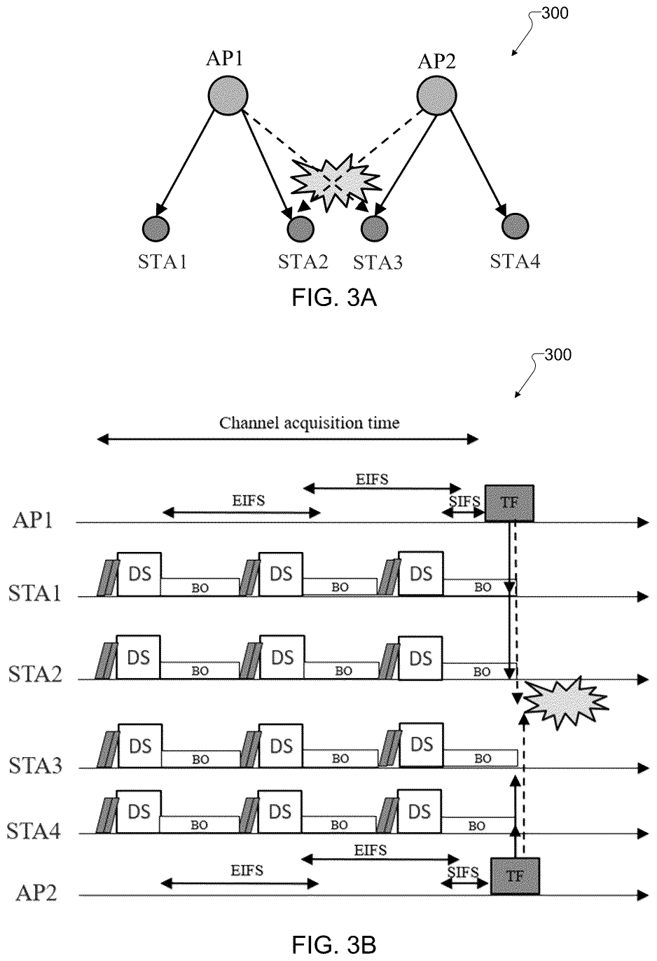

In high priority (Hip) enhanced distributed channel access (EDCA), a collision could occur when multiple APs provide scheduling simultaneously. An example of such contention within a multi-basic service set (BSS) environment is described in FIG. 3a and FIG. 3b.

FIGS. 3A and 3B illustrate an example of a collision in a multi-BSS environment 300 according to embodiments of the present disclosure. The embodiment of a collision in a multi-BSS environment of FIGS. 3A and 3B is for illustration only. Different embodiments of a collision in a multi-BSS environment could be used without departing from the scope of this disclosure.

In the example of FIGS. 3A and 3B, several latency sensitive stations (STA1 and STA2) and (STA3 and STA4) are in two BSSs attempting to access the channel by using high priority enhancement EDCA. AP1 and AP2 do not have LLT and no defer signals (DSs) are sent from AP1 and AP2. STA1 and STA2 appear to transmit a DS at the same time, resulting in a collision. This collision occurs because multiple stations accessed the channel simultaneously. After detecting a collision, the STAs and Access Points are forced into an extended interframe space (EIFS) protection, which is used by devices to defer their next transmission following an error. After several rounds of collision, none of the STAs have won the channel, and each of AP1 and AP2 initiate a trigger frame (TF) to manage the channel and assist the stations in re-accessing channel. Despite AP1 and AP2 trying to control the channel by sending trigger frames, another round of collisions may occur at the overlapping BSS (OBSS) STAs since AP1 and AP2 have transmitted their TFs at the same time.

FIGS. 3A and 3B illustrate illustrates one example of a collision in a multi-BSS environment 300, various changes may be made to FIGS. 3A and 3B. For example, various changes to the number of APs and the number of STAs could be made, etc., according to particular needs.

In existing wireless networks, multiple ultra-high reliability (UHR) LL STAs may transmit before STAs without LL support contend the channel. Therefore, the LL STAs may have a higher chance to win the channel. However, when there are multiple LL STAs, contention cannot be avoided and collisions may occur among the LL STAs.

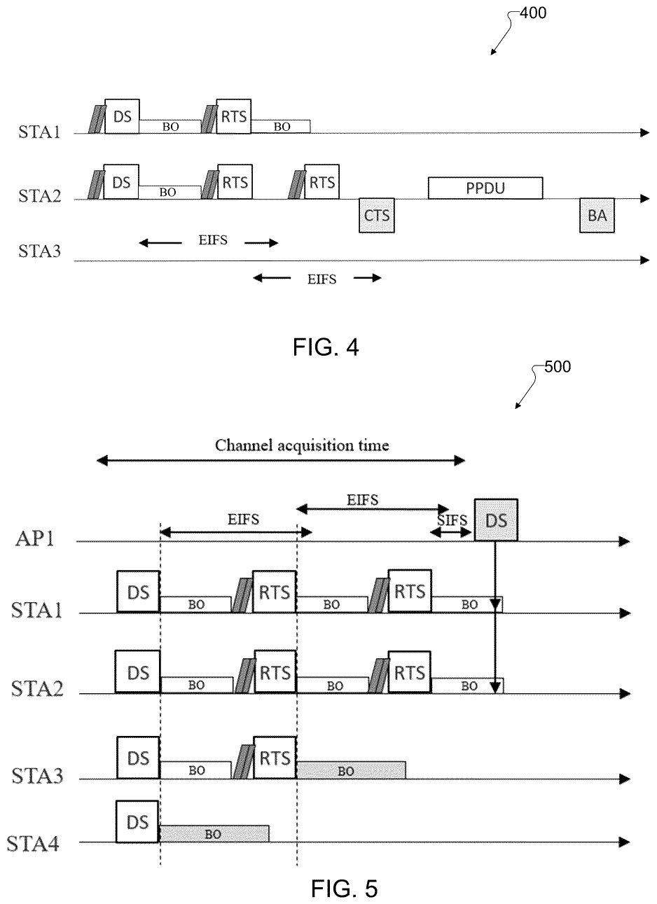

When the LL STAs transmit DSs and collisions occur, then retransmission of DSs follow until one of the LL STAs wins the channel. Defer signals such as request to send (RTS), clear to send (CTS), etc., can be used for contention and retransmission among the LL STAs. In these circumstances The STAs without LL support are forced into EIFS during the retransmission. When one of the STAs wins the channel, a CTS is transmitted from the receiver. An example is shown in FIG. 4

FIG. 4 illustrates an example of enhanced EDCA with collision and retransmission with RTS 400 according to embodiments of the present disclosure. The embodiment of enhanced EDCA with collision and retransmission with RTS of FIG. 4 is for illustration only. Different embodiments of enhanced EDCA with collision and retransmission with RTS could be used without departing from the scope of this disclosure.

In the example of FIG. 4, each low latency station (STA1 and STA1) participates in a contention-based access using defer signals such as RTS, CTS, etc., frames and back-off periods, which helps isolated non-LLT capable STAs (STA 3) reduce collision probability. Retransmission of DSs follows from STA1 and STA 2 until STA1 wins the channel. STA 3 is forced into EIFS during the retransmissions. After winning the channel, STA 1 transmits a CTS.

Although FIG. 4 illustrates one example of enhanced EDCA with collision and retransmission with RTS 400, various changes may be made to FIG. 4. For example, various changes to the number of STAs could be made, etc., according to particular needs.

There is a chance that repeated collisions could result in prolonged channel acquisition times which can lead to significant delays in low-latency communication, especially in dense scenarios. To reduce the long channel acquisition time, AP intervention may complement Hip EDCA and enhance its effectiveness in supporting low-latency communication. An example of collision and AP intervention is shown in FIG. 5.

FIG. 5 illustrates an example of enhanced EDCA with collision and retransmission 500 according to embodiments of the present disclosure. The embodiment of enhanced EDCA with collision and retransmission of FIG. 5 is for illustration only. Different embodiments of enhanced EDCA with collision and retransmission with RTS could be used without departing from the scope of this disclosure.

In the example of FIG. 5, each low latency station (STA1 through STA4) participates in a contention-based access using defer signals such as RTS, CTS, etc., frames and back-off periods. Due to a large number of collisions, AP1 decides to offer scheduling for the low latency (LL) STAs, and thus contends the channel after SIFS. After winning the channel, AP1 coordinates subsequent communication activities.

Although FIG. 5 illustrates one example of enhanced EDCA with collision and retransmission 500, various changes may be made to FIG. 5. For example, various changes to the number of APs and the number of STAs could be made, etc., according to particular needs.

In existing wireless networks, it is unclear how an AP may intervene and detect or count the DSs collision with AP control. For example, the AP may be unable to determine which STAs are sending the DSs, and how many rounds of the DSs have been transmitted. If STAs can join or quit the current contention period is unclear.

In addition, when a STA receives a frame with a failed FCS, the STA only knows that an error has occurred in the frame. This could result from a variety of issues, including collisions, interference, or noise, etc. The AP does not have a mechanism to distinguish between these reasons based solely on FCS failure, which may result in the difficulty for AP offering scheduling in Hip EDCA. Furthermore, sending a CTS may result from other mechanisms such as OFDM protection in 2.4 GHz.

Another problem is that LL STAs only transmit to one STA at a time, since an RTS-CTS pair is only for one receiver at a time. Therefore, the methods used in FIG. 4 and FIG. 5 may not be able to extend to multi-user scenarios directly.

STAs in power save mode (PSM) may not be able to receive or synchronize with the last frame transmitted before a DS control frame, which can cause issues. Additionally, when a power-saving STA prepares to contend for the next P-EDCA session, it may not be able to synchronize with other participating STAs, leading to potential contention mismatches and stringent synchronization problems.

PSM STAs may not have received a recent frame. If a STA wakes up after a long sleep interval, the STA may not have a fresh reference for CFO or symbol clock alignment. This means the STA's timing could be off, affecting its DS or RTS transmission.

As noted above, in Hip EDCA a collision could occur when multiple APs provide scheduling simultaneously. The present disclosure provides mechanisms to help avoid such collisions.

In some embodiments, STAs first may prioritize their latency traffic, then based on some conditions, APs can offer scheduling with contention. For example, the conditions may include long channel acquisition time, including but not limited to a congested network with multiple LLT or STAs, multiple collisions, etc.

In some embodiments, a mechanism allowing Hip EDCA among APs may be defined, in which an AP can schedule the LLT for the STAs in the AP's BSS.

In some embodiments, an AP may prioritize the AP's BSS with LLT after several rounds of contention.

In some embodiments, an AP may prioritize the AP's BSS with LLT after at most one round of contention.

In some embodiments, an AP may prioritize the AP's BSS with LLT at the beginning of a contention period. For example, in some embodiments the AP may directly send a DS after a short interframe space (SIFS)/point coordination function (PCF) interframe space (PIFS) of the previous transmission opportunity (TXOP).

In some embodiments, to provide better cooperation for enhancing the Hip EDCA among multiple BSSs, the respective APs of the BSSs may indicate or share Hip EDCA requests and schedules for better coordination.

In some embodiments, for improved efficiency, the Hip EDCA may include an adaptive back-off mechanism and parameters.

In some embodiments, STAs or APs may take turns to schedule the Hip EDCA.

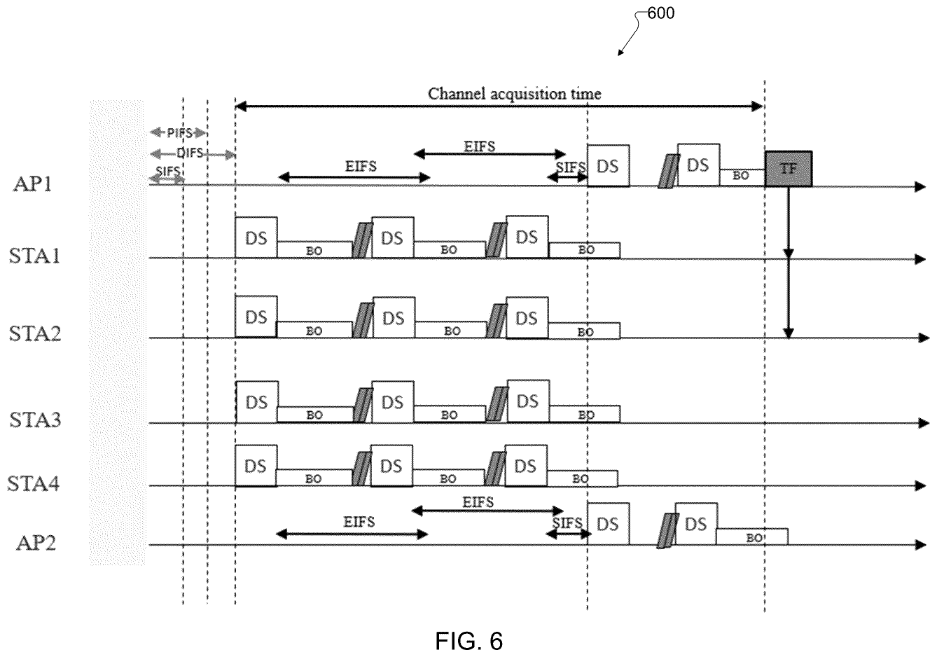

In some embodiments, a Hip EDCA among APs may happen after several rounds of contention among non-AP STAs, similar as shown in FIG. 6.

FIG. 6 illustrates an example of Hip EDCA among APs after multiple rounds of contention 600 according to embodiments of the present disclosure. The embodiment of Hip EDCA among APs of FIG. 6 is for illustration only. Different embodiments of Hip EDCA among APs after multiple rounds of contention could be used without departing from the scope of this disclosure.

In the example of FIG. 6, Hip EDCA with AP control among multiple BSSs is shown. The example of FIG. 6 may be referred to as HIP EDCA Mode B option 1. FIG. 6 depicts two access points (AP1 and AP2) and four stations (STA1 to STA4), each following a sequence of events involving various inter-frame spacing and contention parameters to coordinate access to the shared communication channel.

Each low latency station (STA1 through STA4) participates in a contention-based access using defer signals such as RTS, CTS, etc., frames and back-off periods, after the previous TXOP by distributed coordination function (DCF) interframe space (DIFS), which helps isolated non-LLT capable STAs reduce collision probability. Due to a large number of collisions, AP1 and AP2 decide to offer scheduling for the low latency (LL) STAs, and thus contend the channel after SIFS. Because multiple APs sending a DS may also collide, they APs may retransmit the defer signal with high priority parameters. After winning the channel, AP1 transmits a trigger frame to coordinate subsequent communication activities.

In some embodiments, an AP may wait more than one or two rounds of contention and then contend the channel.

Although FIG. 6 illustrates one example of Hip EDCA among APs after multiple rounds of contention 600, various changes may be made to FIG. 6. For example, various changes to the number of APs and the number of STAs could be made, etc., according to particular needs.

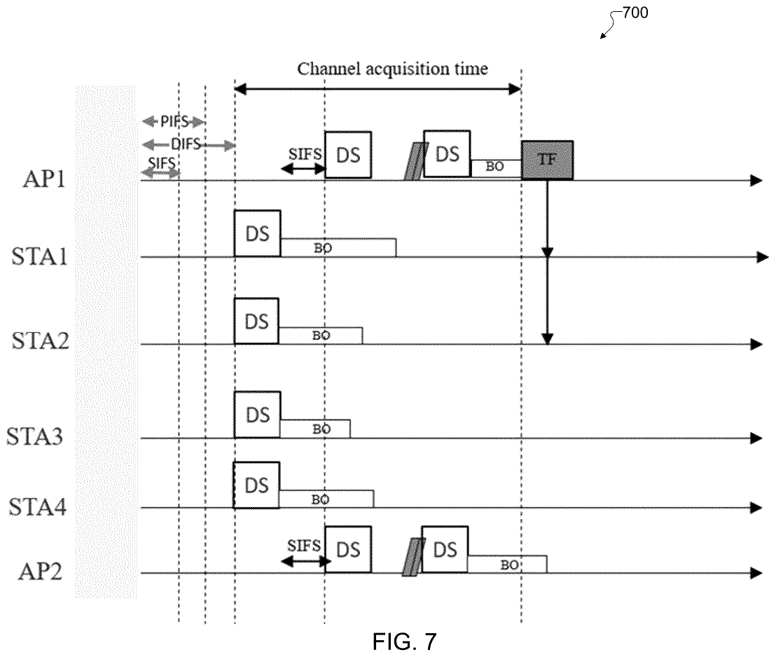

In some embodiments, Hip EDCA among APs may occur after one round of DS among non-AP STAs, similar as shown in FIG. 7.

FIG. 7 illustrates an example of Hip EDCA among APs after a single round of contention 700 according to embodiments of the present disclosure. The embodiment of Hip EDCA among APs of FIG. 7 is for illustration only. Different embodiments of Hip EDCA among APs after a single round of contention could be used without departing from the scope of this disclosure.

In the example of FIG. 7, Hip EDCA with AP control among multiple BSSs is shown. The example of FIG. 7 may be referred to as HIP EDCA Mode B option 2. FIG. 7 depicts two access points (AP1 and AP2) and four stations (STA1 to STA4), each following a sequence of events involving various inter-frame spacing and contention parameters to coordinate access to the shared communication channel.

Each low latency station (STA1 through STA4) may send respective DSs and then the APs accesses the channel to end the contention among LL STAs using defer signals such as RTS, CTS, etc. The APs (which are from multiple BSSs) contend the channel to decide who can offer scheduling for the LL STAs. After winning the channel, AP1 transmits a trigger frame to coordinate subsequent communication activities.

In some embodiments, an AP may wait one round of DSs and then contend the channel.

Although FIG. 7 illustrates one example of Hip EDCA among APs after a single round of contention 700, various changes may be made to FIG. 7. For example, various changes to the number of APs and the number of STAs could be made, etc., according to particular needs.

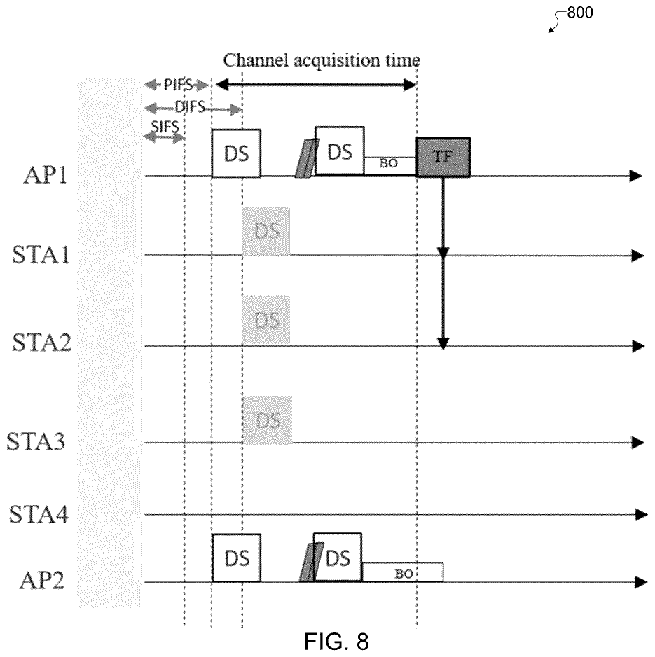

In some embodiments a Hip EDCA among APs may occur right after the previous TXOP. For example, an AP may directly send a DS after the SIFS/PIFS of the previous TXOP, similar as shown in FIG. 8.

FIG. 8 illustrates an example of Hip EDCA among APs 800 according to embodiments of the present disclosure. The embodiment of Hip EDCA among APs of FIG. 8 is for illustration only. Different embodiments of Hip EDCA among APs could be used without departing from the scope of this disclosure.

In the example of FIG. 8, Hip EDCA with AP control among multiple BSSs is shown. The example of FIG. 8 may be referred to as HIP EDCA Mode B option 3. FIG. 8 depicts two access points (AP1 and AP2) and four stations (STA1 to STA4), each following a sequence of events involving various inter-frame spacing and contention parameters to coordinate access to the shared communication channel.

Each low latency station, STA1 through STA4, may not send the defer signals, for example, due to latency sensitive traffic as in FIG. 6 and FIG. 7. Instead, AP1 and AP2 from directly contend the channel after SIFS or PIFS or DIFS to decide who can offer scheduling for the LL STAs. After winning the channel, AP1 and transmits a trigger frame to coordinate subsequent communication activities.

In some embodiments, multiple APs who may offer scheduling may wait for an IFS time to send a DS and then contend the channel.

Although FIG. 8 illustrates one example of Hip EDCA among APs 800, various changes may be made to FIG. 8. For example, various changes to the number of APs and the number of STAs could be made, etc., according to particular needs.

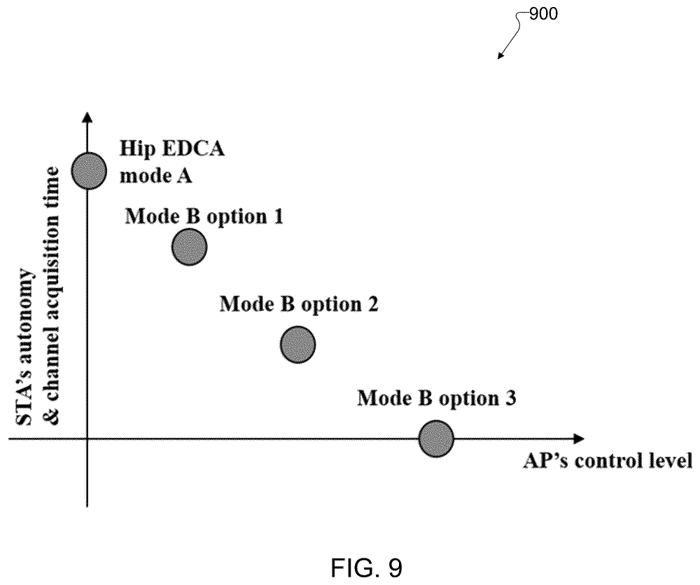

An example of the relationship between HIP EDCA Mode B option 1, option 2 and option 3 is shown in FIG. 9.

FIG. 9 illustrates an example Hip EDCA mode relationship 900 according to embodiments of the present disclosure. The embodiment of a Hip EDCA mode relationship of FIG. 9 is for illustration only. Different embodiments of a Hip EDCA mode relationship could be used without departing from the scope of this disclosure.

In the example of FIG. 9, the x-axis denotes the AP's control. The further along the x-axis, the larger, the control strength of the AP. The y-axis denotes the STA's autonomy. The further along the y-axis, the larger the freedom of STAs to contend the channel without AP control. The y-axis may also denote the channel acquisition time, more randomness, more collisions, and more channel acquisition time. For example, Mode B option 3 is directly controlled by an AP, in which the AP sends the trigger frame and polls the LL traffic from the LL STAs. Mode A allows STAs to contend themselves without AP control. Mode B option 1 and Mode B option 2 are in between Mode A and Mode B.

Although FIG. 9 illustrates one example Hip EDCA relationship 900, various changes may be made to FIG. 9. For example, various changes to the number of modes could be made, etc., according to particular needs.

In some embodiments, APs may coordinate with each other to avoid collisions in supporting multiple LL STAs in multiple BSSs. For example, a coordinated target wake time (TWT) or coordinated time division multiple access TDMA can be implemented between the coordinating APs. In embodiments such as these, APs in the multiple AP (MAP) may share information such as the EDCA Enhancement element, capability of enhanced EDCA, the start time, end time, periodicity, duration of LL session, bandwidth of LL session, etc. in a coordinated MAP (C-MAP).

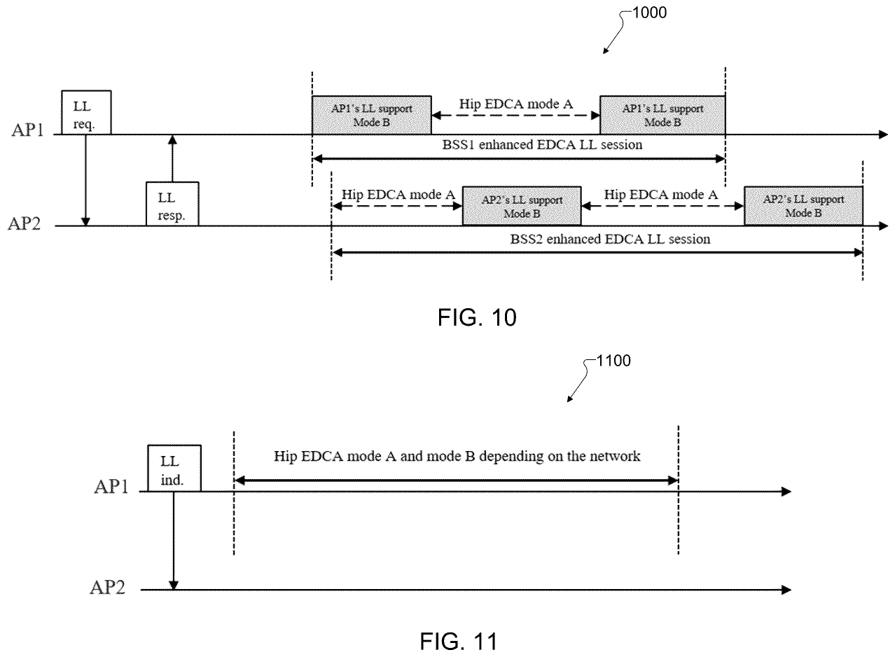

FIG. 10 illustrates an example mechanism for Hip EDCA with MAP coordination in LL sessions 1000 according to embodiments of the present disclosure. The embodiment of Hip EDCA with MAP coordination in LL sessions of FIG. 10 is for illustration only. Different embodiments of Hip EDCA with MAP coordination in LL sessions could be used without departing from the scope of this disclosure.

In the example of FIG. 10, two APs (AP1 and AP2) coordinate to support LL sessions across multiple BSSs. This coordination includes request and response frame exchanges to establish an LL session and share relevant configuration information between AP1 and AP2.

In some embodiments, a Low-Latency Request (LL req.) may be initiated when an AP (e.g., AP1) sends an LL req. frame to the responding AP (e.g., AP2.) In embodiments such as these, the LL request frame may include one or more information items shown in Table 1, and the LL response frame may include one or more information items shown in Table 2.

TABLE 1
Information items in LL request frame

| Fields | Description. |
|---|---|
| Session Type | Defines the session as low-latency. |
| EDCA Enhancement | Specifies the enhanced EDCA features |
| Element | supported by the initiating AP. |
| Mode Indicator | Indicates the EDCA mode (e.g., Mode A |
| | for initiating low-latency mode, Mode B |
| | for ongoing support). |
| Session Parameters | Information items that define the start |
| | time, end time, periodicity, and duration |
| | of the LL session. |
| Bandwidth Allocation | Specifies the bandwidth requirements for |
| | the LL session in the coordinated MAP |
| | (C-MAP). |

TABLE 2
Information items in LL response frame

| Fields | Description. |
|---|---|
| Acknowledgment | Confirms receipt of the LL req. frame. |
| EDCA Enhancement | Specifies the enhanced EDCA features |
| Element | supported by the responding AP. |
| Mode Indicator | Indicates the EDCA mode (e.g., Mode A |
| | for initiating low-latency mode, Mode B |
| | for ongoing support). |
| Session Parameters | Reiterates or adjusts the parameters for |
| | the LL session based on responder's |
| | capabilities, AP2 in this case. |
| Resource Allocation | Confirms the bandwidth allocation and |
| Confirm | session timings agreed upon. |

For LL session coordination, in some embodiments APs in multiple BSSs may coordinate HIP EDCA Modes to initiate a low-latency session. During this procedure, the protocols and rules are decided. Once the session is established, the APs may switch from the current HiP EDCA Mode to another mode, and maintain support for ongoing LL traffic without further contention.

In some embodiments, the APs (e.g., AP1 and AP2) share synchronized session timing information to ensure that low-latency requirements are maintained across the BSSs (e.g., BSS1 and BSS2).

In some embodiments, the APs (e.g., AP1 and AP2) may complete the LL req. and LL resp. frame exchange when initiating an LL session.

In some embodiments, the APs (e.g., AP1 and AP2) APs may comply with the EDCA enhancements specified in the EDCA Enhancement Element field to maintain low-latency support.

In some embodiments, the APs (e.g., AP1 and AP2) may adhere to the agreed bandwidth allocation and session timings to minimize channel contention and meet the low-latency requirements.

Although FIG. 10 illustrates one example mechanism for Hip EDCA with MAP coordination in LL sessions 1000, various changes may be made to FIG. 10. For example, various changes to the number of APs could be made, etc., according to particular needs.

In some embodiments, an AP may provide a low-latency indication to another AP, coordinating the support of low-latency sessions dynamically based on network conditions, similar as shown in FIG. 11.

FIG. 11 illustrates an of Hip EDCA with MAP coordination with an LL indication 1100 according to embodiments of the present disclosure. The embodiment of Hip EDCA with MAP coordination with an LL indication of FIG. 11 is for illustration only. Different embodiments of Hip EDCA with MAP coordination with an LL indication could be used without departing from the scope of this disclosure.

In the example of FIG. 11, a first AP (AP1) transmits a low-latency Indication (LL ind.) transmits an “LL ind.” frame to a second AP (AP2), indicating that low-latency support is requested or should be maintained. In some embodiments, the LL ind. frame may include one or more of the information items from table 3.

TABLE 3
Information items in LL indication frame.

| Fields | Description. |
|---|---|
| Indication Type | Specifies whether the indication is to start, |
| | maintain, or end LL support. |
| EDCA Enhancement | Indicates the specific EDCA |
| Element | enhancements being utilized for LL |
| | support. |
| Mode Indicator | Indicates the EDCA mode (e.g., Mode A |
| | for initiating low-latency mode, Mode B |
| | for ongoing support). |
| Modes for Initiation | AP1 instructs AP2 to initiate support for |
| | new low-latency traffic if Mode A is |
| | indicated. |
| Mode for Ongoing | If the indication signals ongoing low- |
| Support | latency requirements, AP2 enters Mode B, |
| | ensuring that LL traffic is prioritized. |

In some embodiments, the second AP (e.g., AP2) may process the LL ind. frame and adjust its EDCA settings accordingly to support the low-latency requirements specified.

In some embodiments, the APs (e.g., AP1 and AP2) may dynamically adjust between Modes A and B based on the low-latency indication, enabling adaptive coordination.

In some embodiments, the APs (e.g., AP1 and AP2) must comply with the enhancements specified in the EDCA Enhancement Confirmation field to support LL requirements effectively.

Although FIG. 11 illustrates one example of Hip EDCA with MAP coordination with an LL indication 1100, various changes may be made to FIG. 11. For example, various changes to the number of APs could be made, etc., according to particular needs.

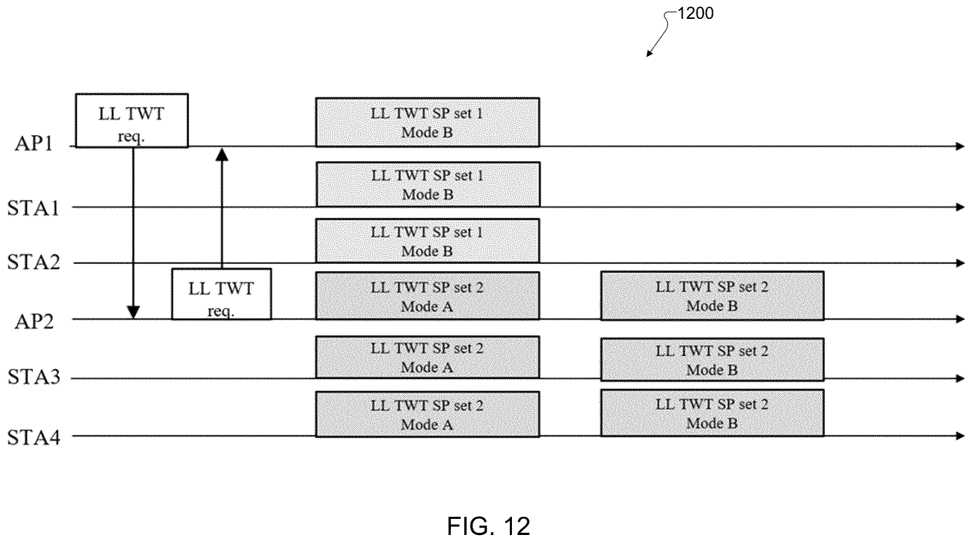

In some embodiments, two APs may coordinate to schedule and manage low latency TWT sessions with different Hip EDCA modes, similar as shown in FIG. 12.

FIG. 12 illustrates an of Hip EDCA with MAP coordination in LL TWT 1200 according to embodiments of the present disclosure. The embodiment of Hip EDCA with MAP coordination in LL TWT of FIG. 12 is for illustration only. Different embodiments of Hip EDCA with MAP coordination in LL TWT could be used without departing from the scope of this disclosure.

In the example of FIGS. 12, AP1 and AP2 coordinate LL TWT sessions among multiple STAs (STA1 to STA4). This allows the APs to establish synchronized TWT schedule periods (SPs) across devices, ensuring that LL requirements are met through managed wake times and prioritized channel access. In some embodiments, LL TWT frames may include one or more information items from Table 4.

TABLE 4
Information items in LL request frame.

| Fields | Description. |
|---|---|
| TWT parameters | Indicate the start time, duration, |
| | periodicity and wake time internals for |
| | each LL TWT session. |
| TWT SP set ID | Indicates the TWT SP set (e.g., Set 1 or |
| | Set 2) to distinguish among different |
| | TWT session groups. |
| Mode Indicator | Indicates the EDCA mode (e.g., Mode A |
| | for initiating low-latency mode, Mode B |
| | for ongoing support). |
| Modes for Initiation | AP1 instructs AP2 to initiate support for |
| | new low-latency traffic if Mode A is |
| | indicated. |
| Mode for Ongoing | If the indication signals ongoing low- |
| Support | latency requirements, AP2 enters Mode B, |
| | ensuring that LL traffic is prioritized. |

AP1 and its associated STAs (STA1 and STA2) participate in LL TWT SP Set 1, with Mode B utilized to prioritize LL traffic. This set operates under a synchronized schedule, so that both AP1 and its STAs adhere to the defined wake times and access periods.

Similarly, AP2 coordinates with its associated STAs (STA3 and STA4) for LL TWT SP Set 2, beginning with Mode A to establish the session and transitioning to Mode B for ongoing support. This SP set enables AP2 and its STAs to operate under prioritized LL conditions without interference from non-LL traffic.

In some embodiments, the APs (e.g., AP1 and AP2) transition between Mode A (session establishment) and Mode B (sustained low-latency operation) based on TWT SP requirements.

In some embodiments, the APs (e.g., AP1 and AP2) synchronize their TWT SP sets so that LL traffic requirements are met across both BSSs, maintaining low latency through coordinated channel access.

In some embodiments, the STAs (e.g., STA1 through STA4) may follow the target wake times defined in their respective TWT SP sets, enabling efficient use of channel resources and minimizing contention.

In some embodiments, APs and STAs within the same TWT SP set may adhere to the same periodicity and duration as defined, so that all devices operate under low-latency conditions with minimal interruptions.

Although FIG. 12 illustrates one example of Hip EDCA with MAP coordination in LL TWT 1200, various changes may be made to FIG. 12. For example, various changes to the number of APs and the number of STAs could be made, etc., according to particular needs.

In some embodiments, APs in different BSSes may take turns to win the channel during the Hip EDCA. For example, the first BSS may take the SP as the high priority SP. Then the second BSS may take the SP afterwards. The interval can be specified during APs' coordination.

In some embodiments, TXOP level round robin may be used in Hip EDCA. For example, in some embodiments, the TXOP holder may take turns. For example, the previous TXOP is taken by AP1, then the next TXOP can be taken by other non-AP STAs or APs except for AP1.

In some embodiments, a back-off counter may adaptively be adjusted based on the congestion of the network.

As noted above, channel access delays may arise related to collisions among LL STAs. Various embodiments in the present disclosure provide mechanisms to reduce or eliminate such delay.

In some embodiments, a defer signal in Hip EDCA can be a CTS, RTS, MU-RTS etc. In embodiments such as these, after the defer signal, an LL STA can send a CTS-to-self, RTS, MU-RTS, etc.

In some embodiments, multiple rounds of contention frames (e.g., RTS) can be managed by an AP. For example, in some embodiments, a retry counter or attempt sequence number can be indicated in a defer signal.

In some embodiments, a threshold number of failed contentions may be allowed in each pre-emption attempt before the LL STAs perform a regular duration back-off that also allows non-LL STAs to contend with equal opportunity. In embodiments such as these, the threshold failed contention number may either be predetermined (for example, in a technical standard document) or the threshold may be indicated by the AP for the BSS of the LL STAs.

In some embodiments, a low latency session setup may be performed such that during the low latency session, the collision of the defer signals can be considered as part of the Hip EDCA contention. In embodiments such as these, the LL STAs contend during the enhanced EDCA contention window. The backoff counter, arbitration interframe space number (AIFSN), and the length of the IFS can be specified during the LL contention procedure.

As described herein, In HIP EDCA contention, LL STAs initiate contention by transmitting a DS, such as a CTS, after the DIFS or PIFS period following the end of a TXOP. This establishes a Hip EDCA contention window. After sending the DS, each STA enters a backoff phase. When the channel is detected as idle, the STA may transmit an RTS to another STA or the AP, anticipating a CTS response. If the channel is sensed as busy or collisions occur during the RTS phase, the contention process adapts accordingly.

In some embodiments, LL STAs may attempt to transmit multiple rounds of RTS to win the channel, especially in high-collision scenarios. In embodiments such as these, the RTS frames transmitted after DS, may have minor variations (e.g., a unique MAC address field) for each attempt to indicate distinct DS attempts.

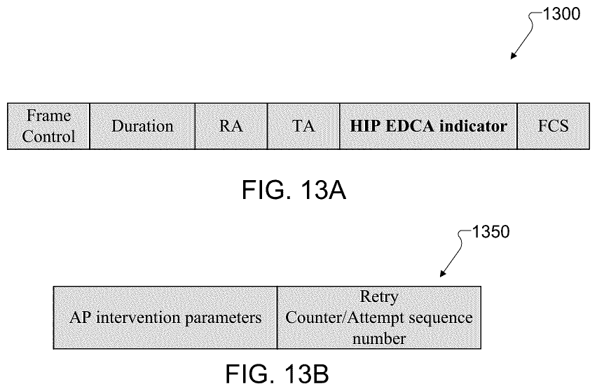

In some embodiments, the RTS is designed for the Hip EDCA contention window. For example, the RTS may include a Hip EDCA field with around 6 Octets, and may may include subfields such as Hip EDCA indicator, retry counter, etc. An example of signaling design for Hip EDCA RTS is shown in FIG. 13A and corresponding subfields are shown in FIG. 13B.

FIGS. 13A and 13B illustrate an example signaling design for a Hip EDCA RTS frame 1300 according to embodiments of the present disclosure. The embodiment of a signaling design for a Hip EDCA RTS frame of FIGS. 13A and 13B is for illustration only. Different embodiments of a signaling design for a Hip EDCA RTS frame could be used without departing from the scope of this disclosure.

In the example of FIG. 13A, the signaling design includes the following fields:
Frame Control
Duration
RA
TA
Hip EDCA indicator
FCS.

The Hip EDCA indicator field may include subfields 1350 as shown in FIG. 13B. Subfields 1350 includes the following subfields:
AP intervention parameters
Retry counter/Attempt sequence number.

In some embodiments, the Hip EDCA indicator field may be a one-bit field in the Hip EDCA RTS frame indicating (e.g., by setting the DS indicator bit to “1”) the Hip EDCA RTS as an RTS during the Hip EDCA contention window. This bit differentiates the Hip EDCA RTS frame from pre-UHR CTS frames used for traditional purposes such as OFDM protection.

In some embodiments, the Hip EDCA indicator field may include multiple subfields. One subfield may be the AP token or parameters such that AP intervention may be allowed to participate in the Hip EDCA contention. For example, if the STA would allow the AP intervene, the STA may set the AP intervention parameter as 1. A minimum retry counter of sending RTS such that AP intervention parameters field was set as 0. For example, an AP or the technical specification may specify a minimum retry of repeated RTSs as 3. After three transmissions of RTS, the STA should set the AP intervention as 1 in which the AP may participate on the control of the channel.

In some embodiments, the BSSID may also be included in the RTS during the Hip EDCA.

In some embodiments, the BSSID can be set as an address of the DS-CTS or DS-RTS.

In some embodiments, another subfield may be the retry counter, which is a parameter that indicates the number of times that the STA tries to contend, and the STA records every time that the STA sends an RTS. For example, each CTS RTS could carry a sequence number to track attempts. This would allow the AP to detect the times of the potential RTS collisions if the AP receives multiple repeated RTS frames with the same sequence numbers. The sequence number in the RTS serves to uniquely identify RTS transmissions attempted by LL STAs.

Although FIGS. 13A and 13B illustrate one example signaling design for a Hip EDCA RTS frame 1300, various changes may be made to FIGS. 13A and 13B. For example, various changes to the fields and subfields could be made, etc., according to particular needs.

In some embodiments, LL STAs may transmit multiple CTS copies as defer signals and/or contending frames. For example, the LL STAs may transmit multiple CTS copies in high-collision scenarios. In embodiments such as these, the repeated CTS frames may be transmitted after DIFS, with minor variations (e.g., a unique MAC address field) for each attempt to indicate distinct DS attempts.

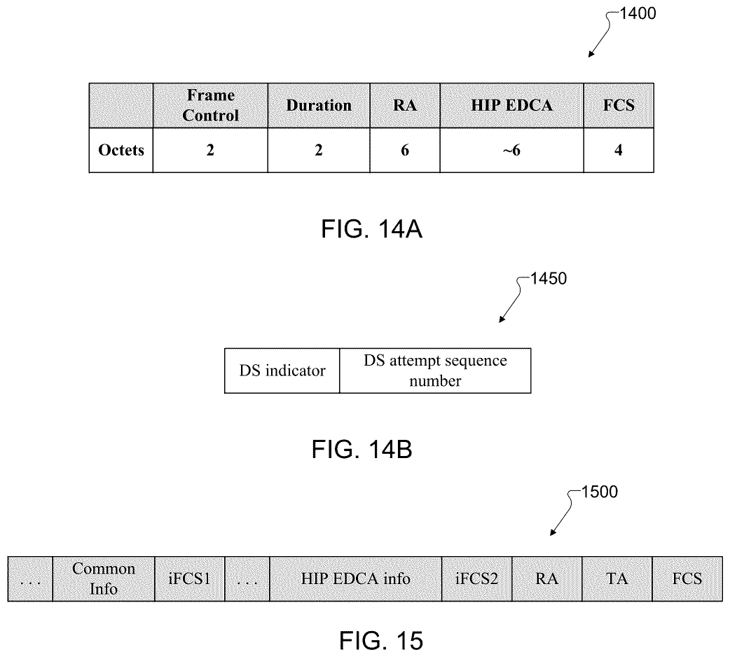

In some embodiments, a DS-CTS may be designed to differentiate a CTS from the DS-CTS. In some embodiments, the DS-CTS may include a Hip EDCA field with around 6 Octets. In some embodiments, the Hip EDCA field may include subfields such as DS indicator, DS attempt sequence number and DS transmission timing. An example of a DS-CTS signaling design is shown in FIGS. 14A and 14B.

FIGS. 14A and 14B illustrate an example signaling design for a Hip EDCA DS-CTS frame 1400 according to embodiments of the present disclosure. The embodiment of a signaling design for a Hip EDCA DS-CTS frame of FIGS. 14A and 14B is for illustration only. Different embodiments of a signaling design for a Hip EDCA DS-CTS frame could be used without departing from the scope of this disclosure.

In the example of FIG. 14A, the signaling design includes the following fields:
Frame Control: 2 octets
Duration: 2 octets
RA: 6 octets
Hip EDCA: approximately 6 octets
FCS: 4 octets.

The Hip EDCA field may include subfields 1450 as shown in FIG. 14B. Subfields 1450 includes the following subfields:
DS indicator
DS attempt sequence number.

In some embodiments, the DS indicator field may be a one-bit field of the CTS frame indicating (e.g., by setting the DS indicator bit to “1”) the CTS frame as a DS-CTS frame. This bit differentiates the DS-CTS frame from pre-UHR CTS frames used for purposes such as OFDM protection. In some embodiments, the DS attempt sequence number field denotes the attempt number or retry counter for each transmitted DS during the Hip EDCA. In some embodiments, the counter may record the contending times of the STA during the Hip EDCA procedure. In some embodiments, each DS-CTS may carry a sequence number to track attempts. This would allow the AP to detect the number of DS collisions if the AP receives multiple repeated DS frames with the same sequence numbers. The sequence number in the DS serves to uniquely identify the DS transmission attempt by LL STAs.

In some embodiments, if the LL STA retries multiple times sending a DS in each Hip contention period, but still not win the channel, the LL STA may request AP intervention by indicating a one-bit in the subsequent RTS's AP intervention parameters subfield.

In some embodiments, information items may also be embedded into DS-RTS frame, and/or other control frames or management frames, similar as shown in FIGS. 14A and 14B. In some embodiments, the RA of the DS-RTS or DS-CTS can be set as a broadcast address or the AP's address. If the AP sends the DS-CTS, the RA field is set as CTS-to-self.

In one embodiment, the defer signal, i.e., DS-CTS, or DS-RTS may set the RA field a special value. In a variant of the embodiment, the special value could be a special reserved MAC Address, or a reserved unicast or multicast MAC address, e.g., DS-SYNC address.

In some embodiments, the NAV of a DS-CTS frame can be set as a default value.

In some embodiments, the TA of a DS-CTS frame can be the STA sending the DS-RTS or a broadcast address.

In some embodiments, the participating P-EDCA STAs may not transmit another round of DS-CTS frame if the STAs do not transmit an RTS to obtain a P-EDCA TXOP.

Although FIGS. 14A and 14B illustrate one example signaling design for a Hip EDCA DS-CTS frame 1400, various changes may be made to FIGS. 14A and 14B. For example, various changes to the fields and subfields could be made, etc., according to particular needs.

In some embodiments, a DS and any subsequent RTS/CTS signals may be sent on the primary 20 MHz channel of the BSS. Correspondingly, in embodiments such as these the Hip EDCA transmission may be performed on the 20 MHz primary channel. Alternatively, in some embodiments, the DS and RTS/CTS can be sent on a predetermined channel of the BSS, such as a 40/80/160/320 MHz primary channel.

In some embodiments, the DS and any subsequent RTS/CTS signals may be sent on the same bandwidth as the TXOP that precedes the transmission of the DS signal. Correspondingly, in embodiments such as these, the HiP EDCA transmission may be performed on the same bandwidth as the transmission that precedes the HiP EDCA. In some embodiments, the DS/RTS/CTS may contain an indication of this bandwidth (for example, via the bandwidth signaling procedure in the Service field of the preamble). Alternatively, in some embodiments, there may be an upper limit of the bandwidth used, which may indicated by a technical standard or by the AP (for example, 40/80/160/320 MHz).

In some embodiments, the off-channel can have a smaller bandwidth (e.g., 5 or 10 MHz) to reduce spectrum usage, or the off-channel can leverage underutilized secondary channels in a wider bandwidth configuration (e.g., 40/80 MHz).

In some embodiment the DS/RTS/CTS may be sent in a predetermined PHY format, such as a non-high throughput (non-HT) duplicate PPDU format.

In some embodiments, LL STAs may operate on a switched or off-channel during the previous TXOP, and then transmit the DS and subsequent RTS/CTS frames. This channel is separate from the primary operational channel of the BSS, allowing the LL STAs to establish contention and manage control signaling without impacting or being impacted by regular traffic on the primary channel.

Alternatively, in some embodiments, the LL STAs may dynamically or statically determine the switched/off-channel through predefined rules or by negotiation with the AP. For example, the AP may announce the off-channel and base-channel for LL operation via Beacon or Probe Response frames.

In some embodiments, if collisions occur on the off-channel during RTS/CTS, the LL STAs can reattempt signaling on the same off-channel or switch to the primary/base channel, depending on AP-defined policies.

In some embodiments, the DS can be sent in a distributed resource unit (d-RU) manner.

In some embodiments, when an AP plans to offer scheduling for LL STAs, the AP may listen to the channel. In some embodiments, the AP may listen for DS and RTS frames within the Hip contention window (e.g., LL session setup, negotiation etc.,) and could expect multiple frames with same sequence numbers. When the sequence number has reached some implementation limit, for example, two or three, the AP may end or intervene the contention by sending another DS after SIFS/PIFS.

In some embodiments, the AP may know the contention attempt by decoding the overlapped frames with the same sequential number. Indirectly, the AP may observe repeated instances where the channel becomes active followed by shorter intervals due to the new shorter backoff windows, which may infer ongoing Hip contentions.

In some embodiments, the AP may detect each collision attempt after the first DS signal by observing a valid PHY preamble in a specific PHY version format (e.g. non-HT), but observing a failure of the FCS check of the MAC frame within the PPDU.

In some embodiments, the sequence number embedded in the DS-CTS is to differentiate from the normal DS, and the sequence number may also indicate to the AP that the DS-CTS is from LL STAs instead of that of OFDM, etc.

In some embodiments, an AP may infer frame collisions by analyzing control frames such as CTS or RTS. For example, if the AP detects multiple CTS or RTS frames with some matching fields such as sequence numbers, or same RA, but mismatched FCS values, or RAs, the AP may deduce that these frames may have collided during the transmission.

In some embodiments, each control frame in a Hip EDCA could include multiple FCS fields covering different sections of the frame, similar as shown in FIG. 15. This allows the AP to assess which portions of the frame were corrupted.

FIG. 15 illustrates an example signaling design for a multi-FCS frame 1500 according to embodiments of the present disclosure. The embodiment of a signaling design for a multi-FCS frame of FIG. 15 is for illustration only. Different embodiments of a signaling design for a multi-FCS frame could be used without departing from the scope of this disclosure.

In the example of FIG. 15, the signaling design includes the following fields:
Common Info
iFCS1
Hip EDCA info
iFCS2
RA
TA
FCS.

In some embodiments, if some intermediate FCS values for the header and common info match but some intermediate FCS (iFCS) or the FCS field of the directions such as RA, or TA fails, the AP may infer partial frame corruption likely caused by a Hip EDCA collision rather than a full collision or interference. In some embodiments, the iFCS may cover the check for all the bits from the start of the MAC frame up to the location of the iFCS. In some embodiments, the iFCS may only cover the check for a subset of the bits preceding it in the MAC frame. For example, the bits of the MAC header may be skipped by the iFCS value.

In one embodiment the transmission by the LL STAs after the first DS signal can be trigger frames containing the intermediate FCS fields. In one embodiment, the RA of the transmission may be set to a common value that is used by all LL STAs. There may be a separate indication in the transmitted frame body to indicate the identity of the transmitter. For example, this can be indicated by the AID12 field in a User Info field included in the transmitted trigger frame. The location of this User Info field may be after an iFCS field included within the trigger frame.

In some embodiments, to enhance collision detection granularity, control frames such as CTS or RTS may include multiple short CRCs, each corresponding to different subfields within the frame. For example, if only a subset of these CRCs matches, the AP can infer that a partial collision occurred (i.e., specific portions of the frame overlapped or were corrupted). In some embodiments, multiple short CRCs may be carried into one RTS frame. For example, an intermediate CRC1 (I-CRC1) which covers until the Common Info field, and an I-CRC2 which covers until the sequential number. The normal CRC covers the whole values. If CRC1 is correct, CRC2 is also correct, but the normal CRC is not correct, the AP may infer that only the subfield corresponding to RA and TA may fail as a partial collision. Since the TA of the RTS may be different. If CRC1 is correct, CRC2 is incorrect and CRC is incorrect, this may imply an RTS from a different BSS and sending different Hip EDCA info.

In some embodiments, an iFCS3 can be applied before the normal FCS, in which the AP may check the RA or TA or a specific field.

Although FIG. 15 illustrates one example signaling design for a multi-FCS frame 1500, various changes may be made to FIG. 15. For example, various changes to the fields could be made, etc., according to particular needs.

In some embodiments, STAs may transmit their DS-CTS with slight offsets after DIFS, which may reduce the likelihood of overlapping signals, which in turn may reduce collisions among LL STAs.

In some embodiments, an AP may consider to perform any signal synchronization methods for DSs. For example, the AP may transmit or broadcast a frame at the end of the TXOP for synchronizing the participating P-EDCA STAs.

In some embodiments, the DS-CTSs from the participating STAs may be synchronized without assistance from the AP. For example, the STAs may synchronize with the last frame from the previous TXOP.

The AP's primary role in intervening during periods of high contention is to facilitate channel acquisition times remaining within acceptable limits. The particular ways the AP intervene (e.g., channel acquisition time thresholds/limits, etc.) can be AP implementation-dependent. An example of how an AP may intervene may be as follows: The AP can recognize the Hip EDCA started through a successful presence of defer signals and monitor the channel for patterns that suggest unresolved contention. For example, frequent bursts of activity followed by shorter idle intervals may indicate multiple STAs contending with shortened backoff windows. If the AP successfully decodes an RTS frame, it implies that a contention winner has emerged. However, if the AP cannot decode a clear RTS (e.g., due to overlapping transmissions or noise) for a long time, the AP may infer ongoing collisions. In such cases, the AP cannot send an ACK/CTS and instead intervenes afterwards to resolve the contention.

In some embodiments, the AP may and the STAs may set a “contention attempt limit” or “channel acquisition time limit” for a Hip contention window. In some embodiments, this waiting time could also be the protection duration for the AP as its EIFS.

For example, an AP and STAs may agree with a duration (e.g., T=N*ContentionWindow_max), where N is the number of attempts, and ContentionWindow_max is the maximum backoff timer for each contention period (e.g., 3). After the duration or this specific EIFS protection, the AP may start to sense and detect the channel and decide to access or not. If the channel is idle, the AP may jump in. If the channel is first busy and then idle, but the duration is smaller than CTS+SIFS, the AP may still jump in. Otherwise, if the channel is busy for a long time in which the LL STA has started the transmission, The AP may go back to power save or listen mode.

In some embodiments, the AP may monitor the channel and detect the energy on the channel.

Alternatively, in some embodiments, the AP may detect the energy and decide if there was a collision. In some embodiments, the AP may count how many DSs collided at its end. For example, if each DS is transmitted at an energy of E1 the received energy at the AP is at an energy of E2 (lower than E1 due to path loss, etc.). If two DSs collide, then the total energy that the AP should detect and sense would be greater than E2 and less than double E2. Therefore, AP may infer roughly that two STAs may have collided with their DSs.

In some embodiments, sequential number detection and energy detection can both be utilized together such that AP may detect or infer that there is a DS collision.

In some embodiments, the AP can assign tokens for the STAs. In some embodiments, the AP could assign a temporary token to each STA allowing only some STAs with the token to transmit a DS in the next contention attempt. For example, the AP may obtain the buffer status and decide to provide tokens to those STAs who may be approaching their delay boundaries. In some embodiments, a Token can be embedded into a control frame or management frame with one bit. In embodiments such as these, if the Token bit is one, the STA may transmit in the next round.

In some embodiments, the AP can assign a specific number for all the STAs, in which the AP may broadcast the parameters in beacons, probing, association, and authentication, etc. The parameters or tokens may be used by the LL STAs participating in the Hip EDCA. In some embodiments, the STAs may send the DS with these embedded parameters such that the AP may know when the Hip EDCA contention starts.

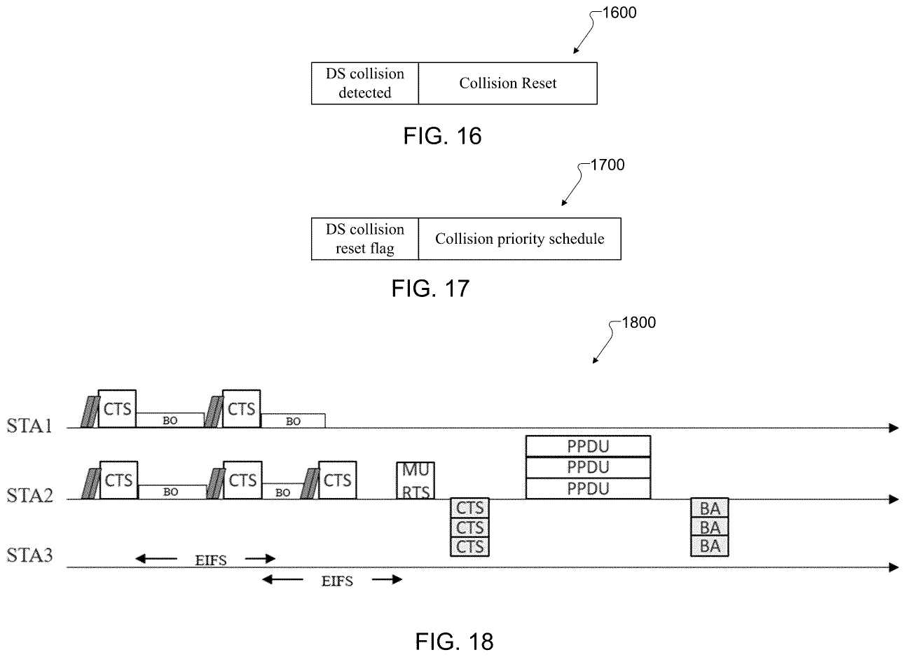

In some embodiments, when the AP detects a corrupted DS that it suspects to be a DS collision, the AP can respond with an ACK or CTS frame containing a “DS collision detected” field or a “collision reset” field, similar as shown in FIG. 16.

FIG. 16 illustrates example information fields in a DS from an AP 1600 according to embodiments of the present disclosure. The embodiment information fields of FIG. 16 are for illustration only. Different embodiments of information fields in a DS from an AP could be used without departing from the scope of this disclosure.

In the example of FIG. 16, these fields would notify LL STAs that a DS collision has occurred, prompting them to stagger their retry attempts.

Although FIG. 16 illustrates one example of information fields in a DS from an AP 1600, various changes may be made to FIG. 16. For example, various changes to the fields could be made, etc., according to particular needs.

In some embodiments, following a DS collision detection, the AP could then send a CTS-to-self similar as shown in FIG. 17 to inform LL STAs to halt their current contention and prepare for a new round.

FIG. 17 illustrates example information fields in a CTS-to self or ACK from an AP 1700 according to embodiments of the present disclosure. The embodiment information fields of FIG. 17 are for illustration only. Different embodiments of information fields in a CTS-to self or ACK from an AP could be used without departing from the scope of this disclosure.

In the example of FIG. 17, the “DS collision reset flag” signals to LL STAs to reset contention due to a detected collision, and “contention priority schedule” specifies the priority order for LL STAs to contend after the collision event. In some embodiments, the CTS-to-self or ACK could also contain a DS priority marker in the control frame, where the AP specifies which LL STA has priority access following a DS collision. This field would allow prioritized STAs to gain immediate access after the AP's intervention, avoiding further collision.

Although FIG. 17 illustrates one example of information fields in a CTS-to self or ACK from an AP 1700, various changes may be made to FIG. 17. For example, various changes to the fields could be made, etc.

In some embodiments, low latency STAs may transmit CTS as defer signals and then transmit any trigger frame to start the transmission, simar as shown in FIG. 18.

FIG. 18 illustrates an example of a prioritized STA sending an MU-RTS after obtaining the channel 1800 according to embodiments of the present disclosure. The embodiment of sending an MU-RTS of FIG. 18 is for illustration only. Different embodiments of a prioritized STA sending an MU-RTS after obtaining the channel could be used without departing from the scope of this disclosure.

FIG. 18 shows an example solution to enhance collision avoidance with LLT. In the example of FIG. 18, the prioritized STAs (i.e., STA1 and STA2) send defer signals (i.e., CTS). STA1 and STA2 are actively transmitting in this example. STA1 and STA2 each initiate a CTS after a backoff period. The BO counters introduce a random delay before each STA sends its CTS, helping reduce simultaneous CTS transmissions. However, there still exists a chance of collision. After two-round of collision in this example, STA2 wins the channel, and sends any trigger frame such as MU-RTS to start the transmission.

Once the CTS is confirmed, the stations proceed with their transmissions of PPDU. STA3, which does not support UHR, follows EIFS rules for medium access. STA3 remains idle due to the busy channel from the ongoing communication of STA1 and STA2. EIFS prevents devices without UHR support from accessing the medium until the channel is deemed idle for a specified duration, reducing the likelihood of interference.

Although FIG. 18 illustrates one example of a prioritized STA sending an MU-RTS after obtaining the channel 1800, various changes may be made to FIG. 18. For example, various changes to the number of STAs could be made, etc., according to particular needs.

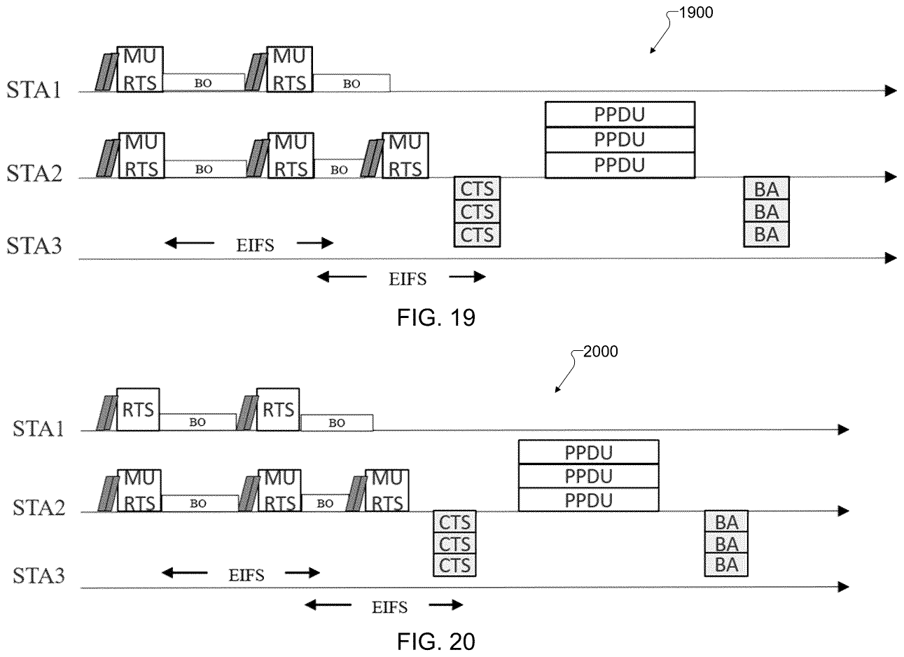

In some embodiments, low latency STAs may transmit MU-RTS as defer signals and the winner LL STAs may expect one or more CTSs, similar as shown in FIG. 19.

FIG. 19 illustrates an example of LL STAs sending MU-RTS as defer signals 1900 according to embodiments of the present disclosure. The embodiment of sending defer signals of FIG. 19 is for illustration only. Different embodiments of LL STAs sending MU-RTS as defer signals 1900 according to embodiments of the present disclosure.

FIG. 19 shows an example solution to enhance collision avoidance with LLT. In the example of FIG. 19, the prioritized STAs (i.e., STA1 and STA2) send defer signals MU-RTS. STA1 and STA2 are actively transmitting in this example. STA1 and STA2 each initiate a MU-RTS after a backoff period. The BO counters introduce a random delay before each STA sends its MU-RTS, helping reduce simultaneous CTS transmissions. However, there still exists a chance of collision. After several rounds of collision in this example, STA2 wins the channel, and expects CTS from receivers. Once CTS is confirmed, the STA proceeds with their transmissions of PPDU. STA3 remains idle due to the busy channel from the ongoing communication of STA1 and STA2. EIFS prevents devices without UHR support from accessing the medium until the channel is deemed idle for a specified duration, reducing the likelihood of interference.

The receiver address (RA) field of this example can be a broadcast address in the MU-RTS.

Although FIG. 19 illustrates one example of LL STAs sending MU-RTS as defer signals 1900, various changes may be made to FIG. 19. For example, various changes to the number of STAs could be made, etc., according to particular needs.

In some embodiments, only the STA (for example, AP, soft AP, AP MLD, etc.) that sends MU-RTS can send the MU-RTS as defer signal. In embodiments such as these, other STAs may send RTS, or CTS as defer signals, similar as shown in in FIG. 20.

FIG. 20 illustrates an example of LL STAs sending MU-RTS and/or RTS/CTS as defer signals 2000 according to embodiments of the present disclosure. The embodiment of sending defer signals of FIG. 20 is for illustration only. Different embodiments of LL STAs sending MU-RTS and/or RTS/CTS as defer signals 1900 according to embodiments of the present disclosure. The embodiment of sending defer signals could be used without departing from the scope of this disclosure.

FIG. 20 shows an example solution to enhance collision avoidance with LLT. In the example of FIG. 20, the prioritized STAs (i.e., STA1 and STA2) send defer signals. STA sends MU-RTS, and STA1 sends RTS. STA1 and STA2 are actively transmitting in this example. STA1 and STA2 each initiate their defer signals after a backoff period. The BO counters introduce a random delay before each STA sends its defer signal, helping reduce simultaneous CTS transmissions. However, there still exists a chance of collision. After several rounds of collision in this example, STA2 wins the channel, and expects CTS from receivers. Once CTS is confirmed, the STA proceeds with their transmissions of PPDU. STA3 remains idle due to the busy channel from the ongoing communication of STA1 and STA2. EIFS prevents devices without UHR support from accessing the medium until the channel is deemed idle for a specified duration, reducing the likelihood of interference.

Although FIG. 20 illustrates one example of LL STAs sending MU-RTS and/or RTS/CTS as defer signals 2000, various changes may be made to FIG. 20. For example, various changes to the number of STAs could be made, etc., according to particular needs.

In some embodiments, there is no restriction that the set of APs may not share the portion of the TXOP from the sharing AP among themselves.

The roles (sharing AP, shared AP) should be consistent in one TXOP. For example, in some embodiments, the shared AP may not be a sharing AP in one TXOP. This is to avoid abusive use (i.e., ping-pong sharing or shared AP shares to another shared AP).

As noted above, PSM STAs may be affected by various issues. The present disclosure provides various mechanisms to reduce or eliminate the impact to the PSM STAs

In some embodiments, a P-EDCA eligible STA, that is going to participate in P-EDCA but is in a power save mode or doze state may listen to an AP announcement or update of the start or parameters of P-EDCA.

In some embodiments, a P-EDCA eligible STA that is going to participate in P-EDCA may wake up earlier by adjusting the NAV for synchronization purposes. For example, the STA may shorten the NAV for a small duration or window for sync. In some embodiments, the STA may shorten the NAV for one PPDU length, or reduce a length of one PPDU plus a SIFS plus an ACK, or reduce a length of SIFS plus ACK, or reduce a length of SIFS, or the STA may wake up slightly earlier, (e.g., a frame duration), which has enough time to perform CFO and symbol clock compensation.

In some embodiments, a P-EDCA eligible STA that is willing to participate in the P-EDCA or who may have pending buffered LLT may wake up a short slot or duration earlier before the ongoing P-EDCA TXOP ends.

In some embodiments, before going to power save mode or doze state, A P-EDCA eligible STA may listen to the ongoing transmission of the TXOP holder, and adjust the NAV for synchronization.

In some embodiments, a P-EDCA eligible STA may enter the power save mode with a normal NAV setting (i.e., no need to awake ahead of time for synchronization, after it successfully obtained a P-EDCA TXOP). Otherwise, the P-EDCA eligible STA may continue such setting of NAV on PS mode up to the limit of retry counters.

In some embodiments, the STAs who participate in P-EDCA are not allowed to be in power save mode until the STA obtains a P-EDCA. In some embodiments, a STA participating in P-EDCA may not enter the PS mode until up to a limit of retry counters.

In some embodiments, an AP may provide a reference timing such as broadcasting beacons or trigger signals, or update the P-EDCA parameters before or during the P-EDCA. This reference may help to align the DS transmission.

In some embodiments, an AP or other STAs can provide a synchronization opportunity before PSM STAs transmit DS.

In some embodiments if an AP detects multiple PSM STAs waking up, the AP can slightly adjust contention timing (e.g., update the AIFSN parameters with a small guard interval) for synchronization.

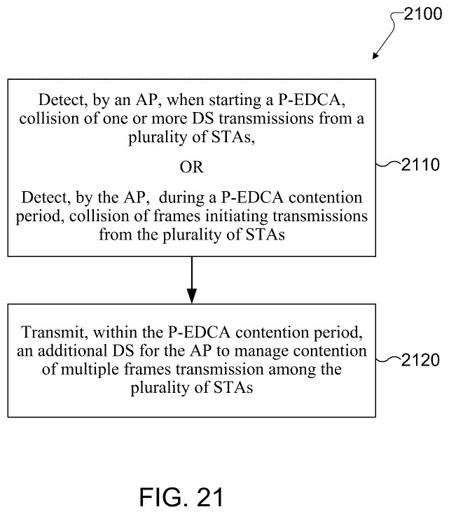

FIG. 21 illustrates an example method for EDCA enhancement in multi-BSS 2100 according to embodiments of the present disclosure. An embodiment of the method illustrated in FIG. 21 is for illustration only. One or more of the components illustrated in FIG. 21 may be implemented in specialized circuitry configured to perform the noted functions or one or more of the components may be implemented by one or more processors executing instructions to perform the noted functions. Other embodiments of a method for EDCA enhancement in multi-BSS could be used without departing from the scope of this disclosure.

In the example of FIG. 21, the method begins at step 2110. At step 2110, an AP (such as AP1 of FIG. 6, 7, or 8) either (i) detects, when starting a P-EDCA, collision of one or more DS transmissions from a plurality of STAs (such as STAs 1-4 of FIG. 6, 7, or 8), or (ii) detects, during a P-EDCA contention period, collision of frames initiating transmissions from the plurality of STAs.

At step 2120, the AP transmits, within the P-EDCA contention period, an additional DS for the AP to manage contention of multiple frame transmission among the plurality of STAs

In some embodiments, each of the DS transmissions from the plurality of STAs and the additional DS may have a non-HT duplicate PPDU format.

In some embodiments, the frames initiating transmissions from the plurality of STA during the P-EDCA may be control frames.

In some embodiments, each of the DS transmissions or the frames initiating the transmissions from the plurality of the STAs and the additional DS may be transmitted on a same channel of a BSS. In some embodiments, the channel of the BSS may be a primary channel of the BSS. In some embodiments, the channel of the BSS may be an off-channel or a base channel, and the AP may, prior to transmission of the DS transmissions and the frames initiating the transmissions from the plurality of STAs, transmit at least one of a beacon or a probe response frame indicating the off-channel and the base-channel.

In some embodiments, the additional DS may include an RA field set to one of CTS-to-self or a special value.

In some embodiments, each of the DS transmissions from the plurality of STAs may include an attempt counter, and the AP may detect a number of potential collisions of the DS transmissions or the frames initiating the transmissions from the plurality of STAs.

In some embodiments, each of the DS transmissions from the plurality of STAs may include an intermediate FCS field, and the AP may detect collision of the DS transmissions or the frames initiating the transmissions from the plurality of STAs when multiple DSs among the DS transmissions from the plurality of STAs have matching fields and mismatched iFCS values.

In some embodiments, during transmission of the additional DS, the AP may contend with another AP to manage the contention of DS transmissions among the plurality of STAs.

In some embodiments, prior to transmission of the DS transmissions by the plurality of STAs, the AP may transmit a reference timing to align transmission of the DS transmissions from the plurality of STAs.

Although FIG. 21 illustrates one example method for EDCA enhancement in multi-BSS 2100, various changes may be made to FIG. 21. For example, while shown as a series of steps, various steps in FIG. 21 could overlap, occur in parallel, occur in a different order, occur any number of times, be omitted, or replaced by other steps.

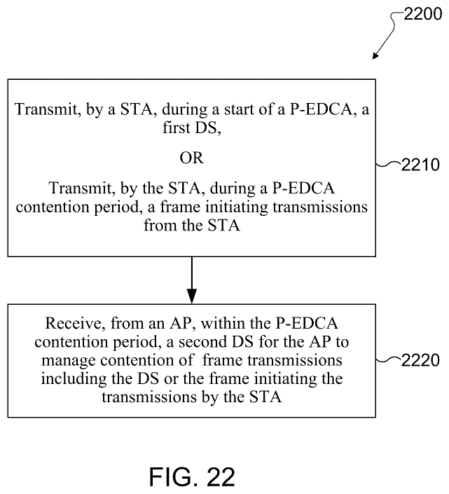

FIG. 22 illustrates another example method for EDCA enhancement in multi-BSS 2200 according to embodiments of the present disclosure. An embodiment of the method illustrated in FIG. 22 is for illustration only. One or more of the components illustrated in FIG. 22 may be implemented in specialized circuitry configured to perform the noted functions or one or more of the components may be implemented by one or more processors executing instructions to perform the noted functions. Other embodiments of a method for EDCA enhancement in multi-BSS could be used without departing from the scope of this disclosure.

In the example of FIG. 22, the method begins at step 2210. At step 2210, STA (such as STA 1 of FIG. 6, 7, or 8) either (i) transmits, during a start of a P-EDCA, a first DS, or (ii) transmits, during a P-EDCA contention period, a frame initiating transmissions from the STA.

At step 2220, the STA receives, from an AP (such as AP1 of FIG. 6, 7, or 8), within the P-EDCA contention period, a second DS for the AP to manage contention of frame transmissions including the DS or the frame initiating the transmissions by the STA.

In some embodiments, the first and the second DS may have a non-HT duplicate PPDU format.

In some embodiments, the frame initiating transmissions from the STA during the P-EDCA is may be a control frame.

In some embodiments, the first and the second DS may be transmitted on a same channel of BSS. In some embodiments, the channel of the BSS may be a primary channel of the BSS. In some embodiments, the channel of the BSS is one of an off-channel or a base-channel, and prior to transmission of the first DS and the frame initiating the transmissions from the STA, the STA may receive at least one of a beacon or probe response frame indicating the off-channel and the base-channel.

In some embodiments, the second DS may include a RA field set to one of CTS-to self or a special value.

In some embodiments, the first DS may include at least one of an attempt counter and an iFCS field.

In some embodiments, prior to transmission of the first DS, the STA may receive a reference timing to align transmission of the first DS.

Although FIG. 22 illustrates one example method for EDCA enhancement in multi-BSS 2100, various changes may be made to FIG. 22. For example, while shown as a series of steps, various steps in FIG. 22 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompasses such changes and modifications as fall within the scope of the appended claims. None of the description in this application should be read as implying that any particular element, step, or function is an essential element that must be included in the claim scope. The scope of patented subject matter is defined by the claims.

What is claimed is:

1. An access point (AP) comprising:
a transceiver; and
a processor operably coupled to the transceiver, the processor configured to:
detect, when starting a prioritized enhanced distributed channel access (P-EDCA), collision of one or more defer signal (DS) transmissions from a plurality of stations (STAs), or
detect, during a P-EDCA contention period, collision of frames initiating transmissions from the plurality of STAs; and
in response to detection of collision of the one or more DS transmissions, or collision of the frames initiating the transmissions from the plurality of STAs, cause the transceiver to transmit, within the P-EDCA contention period, an additional DS for the AP to manage contention of multiple frame transmissions among the plurality of STAs.

2. The AP of claim 1, wherein each of the DS transmissions from the plurality of STAs and the additional DS has a non-high throughput (non-HT) duplicate physical layer protocol data unit (PPDU) format.

3. The AP of claim 1, wherein the frames initiating transmissions from the plurality of STAs during the P-EDCA by are control frames.

4. The AP of claim 1, wherein each of the DS transmissions or the frames initiating the transmissions from the plurality of STAs and the additional DS is transmitted on a same channel of a basic service set (BSS).

5. The AP of claim 4, wherein the channel of the BSS is a primary channel of the BSS.

6. The AP of claim 4, wherein:
the channel of the BSS is one of an off-channel or a base-channel; and
the transceiver is configured to, prior to transmission of the DS transmissions and the frames initiating the transmissions from the plurality of STAs, transmit at least one of a beacon or probe response frame indicating the off-channel and the base-channel.

7. The AP of claim 1, wherein the additional DS includes a Receiver Address (RA) field set to one of clear to send (CTS)-to self or a special value.

8. The AP of claim 1, wherein:
each of the DS transmissions from the plurality of STAs includes an attempt counter; and
the AP is configured to detect a number of potential collisions of the DS transmissions or the frames initiating the transmissions from the plurality of STAs.

9. The AP of claim 1, wherein:
each of the DS transmissions from the plurality of STAs includes an intermediate frame check sequence field (iFCS) field; and
the AP is configured to detect collision of the DS transmissions or the frames initiating the transmissions from the plurality of STAs when multiple DSs among the DS transmissions from the plurality of STAs have matching fields and mismatched iFCS values.

10. The AP of claim 1, wherein during transmission of the additional DS, the AP contends with another AP to manage the contention of DS transmissions among the plurality of STAs.

11. The AP of claim 1, wherein the transceiver is configured to, prior to transmission of the DS transmissions by the plurality of STAs, transmit a reference timing to align transmission of the DS transmissions from the plurality of STAs.

12. A station (STA) comprising:
a processor; and
a transceiver operably coupled to the processor, the transceiver configured to:
transmit, during a start of a prioritized enhanced distributed channel access (P-EDCA), a first defer signal (DS), or
transmit, during a P-EDCA contention period, a frame initiating transmissions from the STA; and
receive from an access point (AP), within the P-EDCA contention period, a second DS for the AP to manage contention of frame transmissions including the DS or the frame initiating the transmissions by the STA.

13. The STA of claim 12, wherein the first and the second DS have a non-high throughput (non-HT) duplicate physical layer protocol data unit (PPDU) format.

14. The STA of claim 12, wherein the frame initiating transmissions from the STA during the P-EDCA is a control frame.

15. The STA of claim 12, wherein the first and the second DS are transmitted on a same channel of a basic service set (BSS).

16. The STA of claim 15, wherein the channel of the BSS is a primary channel of the BSS.

17. The STA of claim 15, wherein:
the channel of the BSS is one of an off-channel or a base-channel; and
the transceiver is configured to, prior to transmission of the first DS and the frame initiating the transmissions from the STA, receive at least one of a beacon or probe response frame indicating the off-channel and the base-channel.

18. The STA of claim 12, wherein the second DS includes a Receiver Address (RA) field set to one of clear to send (CTS)-to self or a special value.

19. The STA of claim 12, wherein the first DS includes at least one of an attempt counter and an intermediate frame check sequence field (iFCS) field.

20. The STA of claim 12, wherein the transceiver is configured to, prior to transmission of the first DS, receive a reference timing to align transmission of the first DS.
